(19) United States
(12) Patent Application Publication
(10) Pub. No.: US 2018/0326657 A1
(43) Pub. Date: Nov. 15, 2018

(54) THREE-DIMENSIONAL MODELING APPARATUS

(71) Applicant: Roland DG Corporation, Hamamatsu-shi (JP)

(72) Inventor: Fumiyoshi IWASE, Hamamatsu-shi (JP)

(21) Appl. No.: 15/976,902

(22) Filed: May 11, 2018

(30) Foreign Application Priority Data
May 15, 2017 (JP) 2017-096391

(51) Int. Cl. B29C 64/165; B29C 64/218; B29C 64/255; B29C 64/393; B33Y 30/00; B33Y 50/02

(52) U.S. Cl. CPC B29C 64/165; B29C 64/218; B33Y 50/02; B29C 64/393; B33Y 30/00; B29C 64/255

(57) ABSTRACT

A three-dimensional modeling apparatus includes a modeling tank including a modeling space that houses a powder material, a modeling table disposed in the modeling space, the powder material being placed on the modeling table, a powder supplier including a supply port and that supplies the powder material into the modeling tank, a filler that fills the modeling space with the powder material from the powder supplier, a modeling head that discharges a curing liquid to the powder material in the modeling tank, and a conveyor that moves the modeling tank from upstream to downstream relative to the powder supplier, the filler, and the modeling head. The supply port of the powder supplier is disposed upstream of the filler and the modeling head. The filler is disposed upstream of the modeling head.

### CROSS REFERENCE TO RELATED APPLICATIONS

This application claims the benefit of priority to Japanese Patent Application No. 2017-096391 filed on May 15, 2017. The entire contents of this application are hereby incorporated herein by reference.

### BACKGROUND OF THE INVENTION

### 1. Field of the Invention

The present invention relates to a three-dimensional modeling apparatus.

### 2. Description of the Related Art

As disclosed in Japanese Patent Application Publication No. 2006-137173, a known three-dimensional modeling apparatus typically models a desired three-dimensional object by discharging an adhesive material to a powder material and curing the powder material.

A three-dimensional modeling apparatus described in Japanese Patent Application Publication No. 2006-137173 includes, for example, a prototyping chamber for housing a powder material, a material containing chamber containing the powder material to be supplied to the prototyping chamber, and a material supplying means for supplying the powder material from the material containing chamber to the prototyping chamber. A printing head for discharging an adhesive material is disposed above the prototyping chamber. The printing head discharges the adhesive material to a portion of the powder material housed in the prototyping chamber and corresponding to a cross-sectional shape of a three-dimensional object. The portion of the powder material housed in the prototyping chamber to which the adhesive material is discharged is cured, thereby forming a powder cured layer conforming to the cross-sectional shape. Such powder cured layers are sequentially stacked so that a desired three-dimensional object is modeled.

The three-dimensional modeling apparatus described in Japanese Patent Application Publication No. 2006-137173 performs the process of supplying the powder material to the prototyping chamber to fill the prototyping chamber with the powder material. Once the prototyping chamber is completely supplied with the powder material and is filled with the powder material, the process of discharging the adhesive material from the printing head is performed. Since the process of supplying and filling the prototyping chamber with the powder material and the process of discharging the adhesive material are completely separate and independently performed as described above, it takes a long time to model a three-dimensional object.

### SUMMARY OF THE INVENTION

Preferred embodiments of the present invention provide three-dimensional modeling apparatuses each capable of reducing the time required to model a three-dimensional object.

A three-dimensional modeling apparatus according to a preferred embodiment of the present invention includes a modeling tank, a modeling table, a powder supplier, a filler, a modeling head, and a conveyor. The modeling tank includes a modeling space that houses a powder material. The modeling table is disposed in the modeling space of the modeling tank, and the powder material is placed on the modeling table. The powder supplier includes a supply port and supplies the powder material into the modeling space of the modeling tank. The filler fills the modeling space with the powder material supplied from the powder supplier. The modeling head discharges a curing liquid to the powder material placed on the modeling table. The conveyor moves the modeling tank at least from the upstream side to the downstream side relative to the powder supplier, the filler, and the modeling head, where the upstream side is one side in a predetermined first direction and the downstream side is another side in the first direction. The supply port of the powder supplier is disposed upstream of the filler and the modeling head. The filler is disposed at the upstream side of the modeling head.

In a three-dimensional modeling apparatus according to a preferred embodiment of the present invention, supply of the powder material from the powder supplier, filling the modeling space with the powder material by the filler, and discharge of the curing liquid from the modeling head, are sequentially performed while the conveyor moves the modeling tank from the upstream side to the downstream side. According to the present preferred embodiment of the present invention, even before supply of the powder material to the modeling tank from the powder supplier is completely finished, filling with the powder material by the filler is sequentially performed from a portion of the modeling space of modeling tank to which the powder material is supplied. Even before filling of the modeling space with the powder material by the filler is completely finished, discharge of the curing liquid from the modeling head is sequentially performed from a portion of the modeling space in which filling with the powder material is completed. Thus, the time required to model a three-dimensional object is able to be reduced, as compared to a three-dimensional modeling apparatus in which the process of supplying a powder material, the process of filling with the powder material, and the process of discharging a curing liquid are completely separate and independently performed.

According to preferred embodiments of the present invention, the time required to model a three-dimensional object is able to be reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a plan view of a three-dimensional modeling apparatus according to a first preferred embodiment of the present invention.

FIG. 2 is a perspective cross-sectional view of the three-dimensional modeling apparatus.

FIG. 3 is a front cross-sectional view of the three-dimensional modeling apparatus taken along line III-III in FIG. 1.

FIG. 4 is a front cross-sectional view of the three-dimensional modeling apparatus, and illustrates a state in which a modeling tank is located below a powder supplier.

FIG. 5 is a bottom view of a modeling head and an ink head, and illustrates a relationship between longitudinal lengths of a modeling nozzle array and an ink nozzle array and a longitudinal length of a modeling space.

FIG. 6 is a front cross-sectional view of the three-dimensional modeling apparatus, and illustrates a state where the modeling tank is located below a heater.

FIG. 7 is a block diagram of the three-dimensional modeling apparatus.

FIG. 8 is a front cross-sectional view of a three-dimensional modeling apparatus according to a second preferred embodiment of the present invention.

FIG. 9 is a front cross-sectional view of a three-dimensional modeling apparatus according to a third preferred embodiment of the present invention.

FIG. 10 is a front cross-sectional view illustrating a three-dimensional modeling apparatus according to a fourth preferred embodiment of the present invention in a partially enlarged manner.

### DETAILED DESCRIPTION OF THE PREFERRED EMBODIMENTS

Three-dimensional modeling apparatuses according to preferred embodiments of the present invention will be described hereinafter with reference to the drawings. The preferred embodiments described herein are not intended to particularly limit the present invention. Elements and features having the same functions are denoted by the same reference numerals, and description for the same members and elements will not be repeated or will be simplified as appropriate.

### First Preferred Embodiment

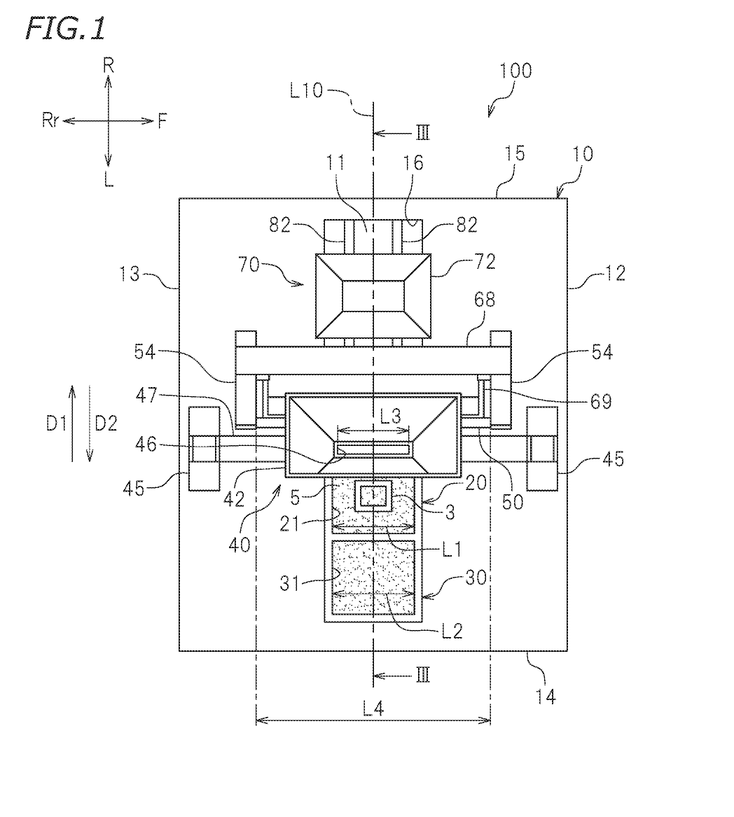

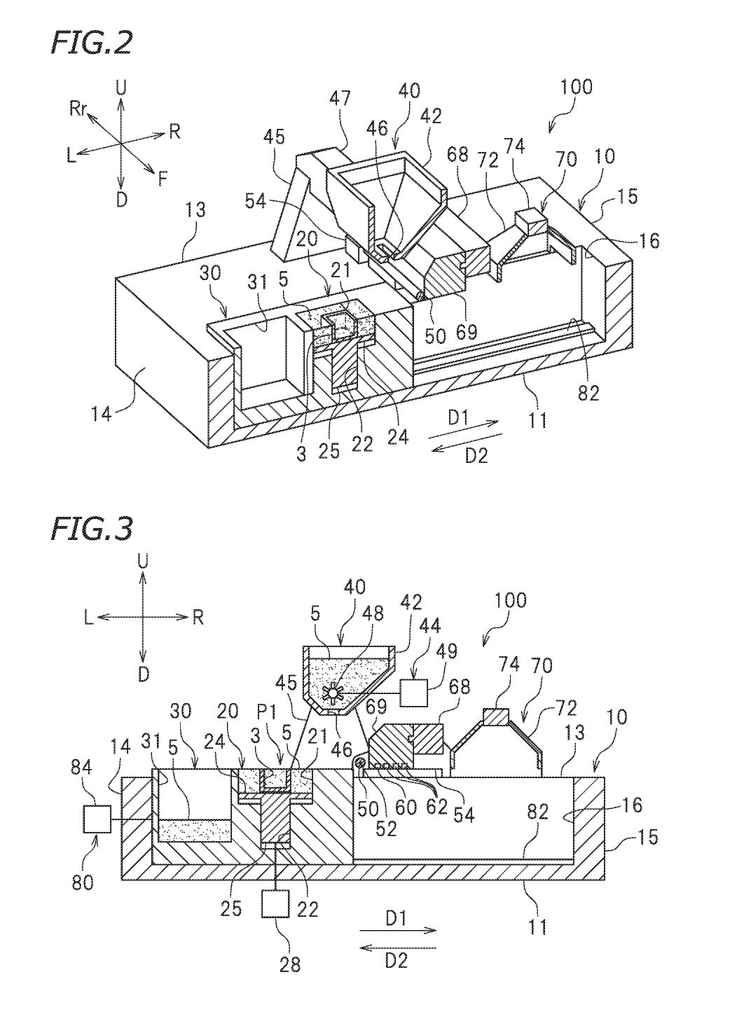

FIG. 1 is a plan view of a three-dimensional modeling apparatus 100 according to a first preferred embodiment of the present invention. FIG. 2 is a perspective cross-sectional view of the three-dimensional modeling apparatus 100. FIG. 3 is a front cross-sectional view of the three-dimensional modeling apparatus 100 in a cross section taken along line III-III in FIG. 1. FIG. 2 is a perspective cross-sectional view of the three-dimensional modeling apparatus 100 illustrated in FIG. 3. Character F in the drawing represents front. Character Rr represents rear. In the present preferred embodiment, left, right, top, and bottom when the three-dimensional modeling apparatus 100 is seen in the direction of character F refer to left, right, top, and bottom, respectively, of the three-dimensional modeling apparatus 100. Here, characters L, R, U, and D in the drawings refer to left, right, top, and bottom, respectively. In the present preferred embodiment, the lateral direction (left-right direction) corresponds to a first direction. The left side of the three-dimensional modeling apparatus 100 will be referred to as an upstream side. The right side of the three-dimensional modeling apparatus 100 will be referred to a downstream side. In the present preferred embodiment, the direction from the upstream side to the downstream side is a forward direction D1. The direction from the downstream side to the upstream side is a backward direction D2. It should be noted that these directions are defined simply for convenience of description, and neither limit the state of installation of the three-dimensional modeling apparatus 100 nor limit the present invention.

As illustrated in FIG. 1, the three-dimensional modeling apparatus 100 models a desired three-dimensional object 3. Here, preferably, the three-dimensional modeling apparatus 100 models a colored three-dimensional object 3. The three-dimensional modeling apparatus 100 models, for example, a full-color three-dimensional object 3. The three-dimensional modeling apparatus 100 may model a colorless three-dimensional object. In the present preferred embodiment, in the three-dimensional modeling apparatus 100, a curing liquid is discharged to a powder material 5 based on a cross-section image showing a cross-sectional shape of a desired three-dimensional object 3. Accordingly, the powder material 5 is cured, and a powder cured layer conforms with the cross-section image. Such powder cured layers are sequentially stacked, thus modeling a desired three-dimensional object 3.

Here, a “cross-sectional shape” refers to the shape of a cross section obtained by repeatedly slicing a three-dimensional object 3 to be modeled in a predetermined direction (e.g., a horizontal direction) to a predetermined thickness (e.g., about 0.1 mm; not necessarily limited to the same thickness). Preferred examples of the “powder material” include gypsum, ceramic, metals, and plastics. The “curing liquid” is not limited to a specific material as long as the powder materials 5 are bonded together. The curing liquid is preferably, for example, a binder. Examples of the binder include a liquid containing water, such as aqueous pigment ink, as a main component.

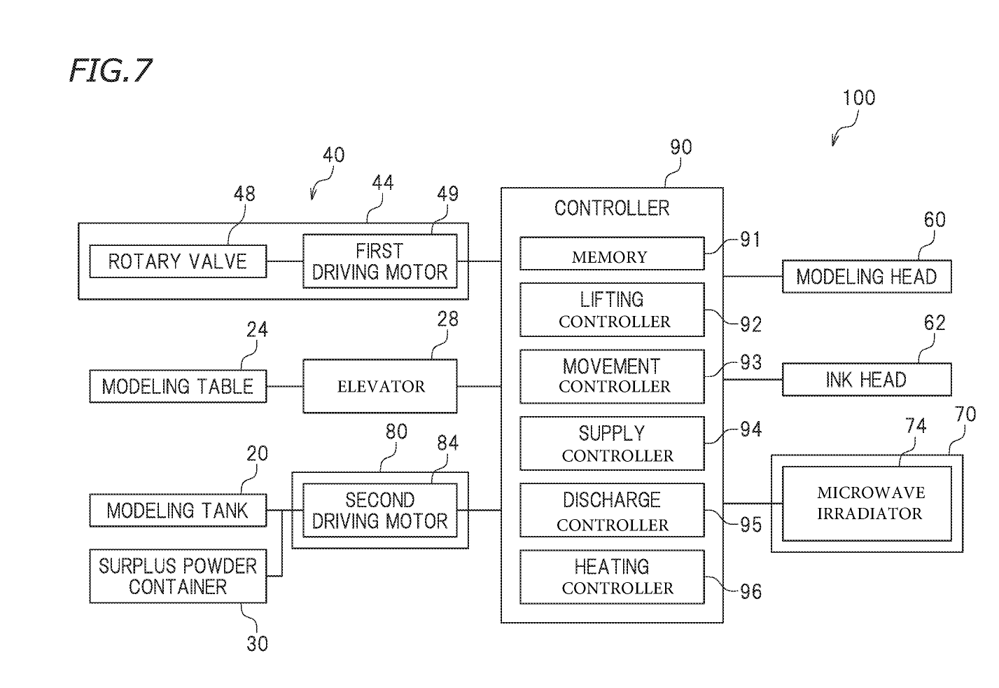

In the present preferred embodiment, as illustrated in FIG. 3, the three-dimensional modeling apparatus 100 includes a body 10, a modeling tank 20, a modeling table 24, an elevator 28, a surplus powder container 30, a powder supplier 40, a filling roller 50, a modeling head 60, ink heads 62, a heater 70, a conveyor 80, and a controller 90 (see FIG. 7).

As illustrated in FIG. 2, the shape of the body 10 is preferably a square pole, for example. The body 10 is, however, not limited to a specific shape. In the present preferred embodiment, as illustrated in FIG. 1, the body 10 includes a bottom wall 11, a front wall 12, a rear wall 13, a left wall 14, and a right wall 15. The front wall 12 extends upward from the front end of the bottom wall 11. The rear wall 13 extends upward from the rear end of the bottom wall 11. The rear wall 13 faces the front wall 12 in a longitudinal direction (front-rear direction). The left wall 14 extends upward from the left end of the bottom wall 11. The right wall 15 extends upward from the right end of the bottom wall 11. The right wall 15 faces the left wall 14 in the lateral direction. In this example, the bottom wall 11, the front wall 12, the rear wall 13, the left wall 14, and the right wall 15 are preferably integrally provided. At least a portion of the bottom wall 11, the front wall 12, the rear wall 13, the left wall 14, and the right wall 15 may be separated from another portion. In the present preferred embodiment, a space surrounded by the bottom wall 11, the front wall 12, the rear wall 13, the left wall 14, and the right wall 15 is a modeling movement space 16.

As illustrated in FIG. 3, the modeling tank 20 is a tank to which the powder material 5 is supplied. In the modeling tank 20, a three-dimensional object 3 is modeled. In the present preferred embodiment, the modeling tank 20 is disposed in the modeling movement space 16 of the body 10. In this example, the modeling tank 20 includes a modeling space 21 and a supporting space 22 therein. The modeling space 21 is supplied with the powder material 5. In the modeling space 21, the three-dimensional object 3 is modeled. The modeling space 21 is not limited to a specific shape. In the present preferred embodiment, the shape of the modeling space 21 is preferably a square pole, for example. The supporting space 22 is continuous with the modeling space 21. The supporting space 22 is located below the modeling space 21. The supporting space 22 is a space extending in a vertical direction (top-bottom direction). The supporting space 22 is a space that is shorter than the modeling space 21 in the lateral direction. The longitudinal length of the supporting space 22 may be smaller than or equal to that of the modeling space 21.

The modeling table 24 is disposed inside the modeling tank 20. Specifically, the modeling table 24 is disposed in the modeling space 21 of the modeling tank 20. The modeling table 24 is slidable in the vertical direction relative to the modeling space 21. The powder material 5 is supplied onto the modeling table 24. The powder material 5 is placed on the modeling table 24. A three-dimensional object 3 is then modeled on the modeling table 24. The three-dimensional object 3 is placed on the modeling table 24. The modeling table 24 is not limited to a specific shape. The shape of the modeling table 24 conforms to the modeling space 21 of the modeling tank 20. The shape of the modeling table is preferably, for example, rectangular or substantially rectangular in plan view. In the present preferred embodiment, the modeling table 24 is provided with a table support 25. The table support 25 extends downward from the bottom surface of the modeling table 24. In this example, the table support 25 is disposed in the supporting space 22 of the modeling tank 20. The table support 25 is slidable in the vertical direction relative to the supporting space 22. The shape of the table support 25 conforms to the supporting space 22, for example.

The elevator 28 moves the modeling table 24 in the vertical direction. The elevator 28 lifts and lowers the modeling table 24. The elevator 28 is not limited to a specific configuration. In the present preferred embodiment, the elevator 28 includes an unillustrated servo motor, an unillustrated ball thread, and other structure. For example, the servo motor is connected to the table support 25, and is connected to the modeling table 24 through the table support 25. When the servo motor is driven, the table support 25 moves in the vertical direction in the supporting space 22. The vertical movement of the table support 25 causes the modeling table 24 to move in the vertical direction.

The surplus powder container 30 is a tank that houses a surplus portion of the powder material 5 not entirely housed in the modeling tank 20 when the modeling tank 20 is supplied and filled with the powder material 5 by the filling roller 50. The surplus powder container 30 houses the powder material 5 removed by the filling roller 50. In the present preferred embodiment, the surplus powder container 30 includes a surplus space 31 that houses the powder material 5 removed by the filling roller 50. The surplus powder container 30 is disposed in the modeling movement space 16 of the body 10. In the present preferred embodiment, the surplus powder container 30 is disposed upstream (at the left here) of the modeling tank 20. The modeling tank 20 and the surplus powder container 30 are arranged side by side in the lateral direction. The modeling tank 20 and the surplus powder container 30 are adjacent to each other. In the present preferred embodiment, the modeling tank 20 and the surplus powder container are preferably integrally provided. Alternatively, the modeling tank 20 and the surplus powder container 30 may be separate members. In this case, the surplus powder container 30 may be attached to the modeling tank 20.

In the present preferred embodiment, as illustrated in FIG. 1, a longitudinal length L1 of the modeling space 21 of the modeling tank 20 is preferably equal or substantially equal to a longitudinal length L2 of the surplus space 31 of the surplus powder container 30 in plan view. Alternatively, the longitudinal length L1 of the modeling space 21 may be smaller than the longitudinal length L2 of the surplus space 31.

As illustrated in FIG. 3, the powder supplier 40 supplies the powder material 5 to the modeling tank 20. In the present preferred embodiment, the powder supplier 40 is disposed above the modeling tank 20. In other words, the powder supplier 40 is disposed above the modeling movement space 16 of the body 10. The powder supplier 40 is not limited to a specific configuration. In the present preferred embodiment, the powder supplier 40 includes a supply vessel 42 and a feeder 44.

The supply vessel 42 houses the powder material 5. The supply vessel 42 is disposed above the modeling movement space 16. In the present preferred embodiment, as illustrated in FIG. 1, two supply supports 45 extending upward are disposed on the upper surface of the body 10. The two supply supports 45 are disposed on the upper surface of the front wall 12 and the upper surface of the rear wall 13, respectively. The two supply supports 45 are opposed to each other with the modeling movement space 16 interposed therebetween in plan view. In this example, a bridge 47 bridges the two supply supports 45. As illustrated in FIG. 2, the supply vessel 42 is disposed on the bridge 47. The supply vessel 42 is not limited to a specific shape. In the present preferred embodiment, as illustrated in FIG. 3, the supply vessel 42 is open at the top. The lateral length of the supply vessel 42 gradually decreases from the top toward the bottom. The longitudinal length of the supply vessel 42 may gradually decrease from the top toward the bottom. In the present preferred embodiment, a side surface of the supply vessel 42 tilts inward toward the bottom. The supply vessel 42 is tapered from the top toward the bottom.

In the present preferred embodiment, as illustrated in FIG. 1, a supply port 46 is provided in the bottom surface of the supply vessel 42. As illustrated in FIG. 3, the supply port 46 is disposed above the modeling movement space 16. The powder material 5 is supplied onto the modeling table 24 in the modeling tank 20 through the supply port 46. In the present preferred embodiment, as illustrated in FIG. 1, the supply port 46 preferably has a rectangular or substantially rectangular shape, for example. The supply port 46 is, however, not limited to a specific shape. In this example, a longitudinal length L3 of the supply port 46 is preferably less than or equal to the longitudinal length L1 of the modeling space 21 of the modeling tank 20. The longitudinal length L3 of the supply port 46 is preferably less than or equal to the longitudinal length L2 of the surplus space 31 of the surplus powder container 30.

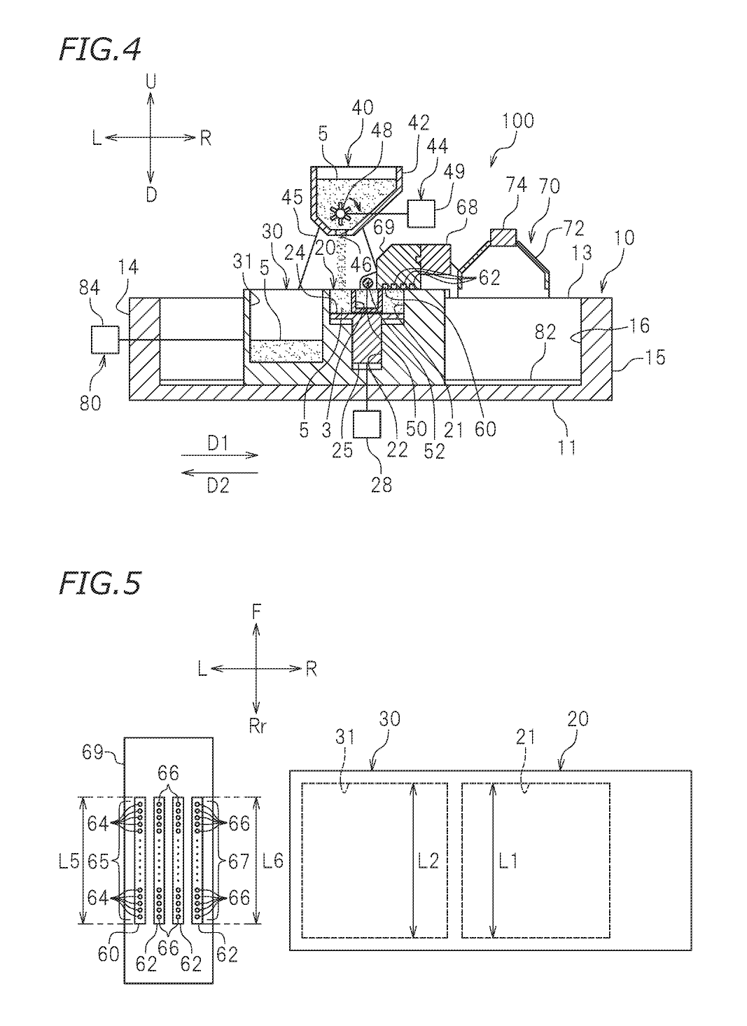

As illustrated in FIG. 3, the feeder 44 supplies the powder material 5 in the supply vessel 42 to the modeling tank 20. The feeder 44 is not limited to a specific configuration. In the present preferred embodiment, the feeder 44 includes a rotary valve 48 and a first driving motor 49. The rotary valve 48 is disposed inside the supply vessel 42. In the present preferred embodiment, the rotary valve 48 is disposed in the supply vessel 42 while being buried in the powder material 5 in the supply vessel 42. The first driving motor 49 rotates the rotary valve 48. The first driving motor 49 is connected to the rotary valve 48. FIG. 4 is a front cross-sectional view of the three-dimensional modeling apparatus 100. FIG. 4 is a view illustrating a state where the modeling tank 20 is located below the powder supplier 40. In this example, as illustrated in FIG. 4, in the state in which the modeling tank 20 is located below the supply port 46 of the supply vessel 42, driving of the first driving motor 49 causes the rotary valve 48 to rotate. The rotation of the rotary valve 48 stirs the powder material 5 in the supply vessel 42. Accordingly, the powder material 5 is partially supplied to the modeling space 21 of the modeling tank 20 through the supply port 46.

The filling roller 50 causes the modeling space 21 to be filled with the powder material 5 supplied to the modeling tank 20. The filling roller 50 removes a surplus portion of the powder material 5 supplied to the modeling tank 20. The filling roller 50 smooths the upper-layer surface of the powder material 5 in the modeling tank 20. In the present preferred embodiment, the filling roller 50 is an example of a “filler”. In the present preferred embodiment, the filling roller 50 is disposed above the modeling movement space 16 of the body 10. The filling roller 50 is disposed downstream (at the right in this example) of the supply port 46 of the supply vessel 42. As illustrated in FIG. 4, the filling roller 50 is disposed at a height at which a portion of the powder material 5 in the modeling tank 20 contacts the filling roller 50 while the modeling tank 20 is located below the filling roller 50. In the present preferred embodiment, the filling roller 50 is located below the supply port 46 of the supply vessel 42. In the present preferred embodiment, as illustrated in FIG. 1, two supports 54 are disposed downstream of the supply port 46 on the upper surface of the body 10. The two supports 54 are disposed on the upper surface of the front wall 12 and the upper surface of the rear wall 13, respectively. The two supports 54 are opposed to each other with the modeling movement space 16 interposed therebetween. The filling roller 50 is rotatably supported by the supports 54. Alternatively, the filling roller 50 may be fixed to the supports 54.

As illustrated in FIG. 3, the filling roller 50 includes a rotating shaft 52 extending longitudinally. The filling roller 50 rotates about the rotating shaft 52. The rotating shaft 52 may extend obliquely relative to a predetermined line L10 (see FIG. 1) extending laterally. The rotating shaft 52 intersects the predetermined line L10 extending laterally.

In the present preferred embodiment, as illustrated in FIG. 1, a longitudinal length L4 of the filling roller 50 is preferably greater than or equal to the longitudinal length L1 of the modeling space 21 of the modeling tank 20. The longitudinal length L4 of the filling roller 50 may be smaller than the longitudinal length L1 of the modeling space 21. In this case, the length L4 of the filling roller 50 is preferably longer than the longitudinal length of a three-dimensional object 3 to be modeled. In the present preferred embodiment, the longitudinal length L4 of the filling roller 50 is preferably greater than or equal to the longitudinal length L2 of the surplus space 31 of the surplus powder container 30. The length L4 is greater than or equal to the longitudinal length L3 of the supply port 46 of the supply vessel 42.

FIG. 5 is a bottom view of the modeling head 60 and the ink heads 62. FIG. 5 is a view illustrating a relationship between longitudinal lengths L5 and L6 of the modeling nozzle array 65 and the ink nozzle array 67, respectively, and the longitudinal length L1 of the modeling space 21. As illustrated in FIG. 5, the modeling head 60 and the ink heads 62 discharge a liquid to the powder material 5. In the present preferred embodiment, the modeling head 60 and the ink heads 62 are preferably line heads, for example. The term “line heads” refers to heads in which the modeling head 60 and the ink heads 62 discharge a liquid when the heads move once in a predetermined direction relative to the modeling table (see FIG. 3) so that a single powder cured layer is produced.

The modeling head 60 discharges a curing liquid to the powder material 5 in the modeling space 21 of the modeling tank 20. The modeling head 60 discharges the curing liquid to a region of the powder material 5 housed in the modeling tank 20 corresponding to a cross-sectional shape conforming to the cross-section image. In the present preferred embodiment, a plurality of modeling nozzles 64 arranged in the longitudinal direction are provided in the bottom surface of the modeling head 60. The plurality of modeling nozzles 64 discharge the curing liquid. An array of the plurality of modeling nozzles 64 will be referred to as the modeling nozzle array 65. The modeling nozzle array 65 may preferably be an array that extends obliquely relative to the predetermined line L10 (see FIG. 1) extending laterally. The modeling nozzle array 65 is an array intersecting the predetermined line L10 extending laterally. In the present preferred embodiment, the modeling nozzles 64 correspond to “nozzles”. The modeling nozzle array 65 corresponds to a “nozzle array”.

The plurality of ink heads 62 discharge ink to the powder material 5 in the modeling space 21 of the modeling tank 20. In the present preferred embodiment, the plurality of ink heads 62 discharge ink to a region of the powder material 5 in the modeling tank 20 to which the curing liquid has been discharged and which corresponds to the cross-sectional shape conforming to the cross-section image. The plurality of ink heads 62 discharge different colors of ink. Ink discharged from each of the ink heads 62 is preferably one of process color inks, such as a cyan ink, a magenta ink, a yellow ink, a light cyan ink, a light magenta ink, and a black ink, and spot color inks such as a white ink, a metallic ink, and a clear ink, for example. In the present preferred embodiment, a plurality of ink nozzles 66 are provided in the bottom surface of each of the ink heads 62 and arranged in the longitudinal direction. These ink nozzles 66 discharge ink. An array of the plurality of ink nozzles 66 in each of the ink heads 62 is referred to as the ink nozzle array 67. The ink nozzle array 67 may preferably be an array extending obliquely relative to the predetermined line L10 (see FIG. 1) extending laterally. The ink nozzle array 67 is an array intersecting the predetermined line L10 extending laterally.

In the present preferred embodiment, the number of modeling head 60 is preferably one, for example. The number of the ink heads 62 is preferably three, for example. Alternatively, a plurality of modeling heads 60 may be provided. The number of the ink heads 62 is not limited to a specific number. The ink heads 62 may be omitted. In the present preferred embodiment, the modeling head 60 and the plurality of ink heads 62 are disposed above the modeling movement space 16 (see FIG. 3) of the body 10. The modeling head 60 and the plurality of ink heads 62 are arranged in the lateral direction. In the present preferred embodiment, the modeling head 60 is disposed upstream of the plurality of ink heads 62. Alternatively, the modeling head 60 may be disposed downstream of the plurality of ink heads 62. The modeling head 60 and the plurality of ink heads 62 are disposed downstream of the supply port 46 (see FIG. 3) of the supply vessel 42 and downstream of the filling roller 50 (see FIG. 3). In the present preferred embodiment, as illustrated in FIG. 1, a head bridge 68 is bridged over portions of the two supports 54 downstream of portions of the two supports 54 supporting the filling roller 50. As illustrated in FIG. 3, the head bridge 68 is disposed above the modeling movement space 16. A head case 69 is disposed in an intermediate portion of the head bridge 68. As illustrated in FIG. 5, the modeling head 60 and the plurality of ink heads 62 are housed in the head case 69 such that the modeling nozzles 64 and the ink nozzles 66 are exposed downward.

As described above, each of the modeling nozzle array 65 of the modeling head 60 and the nozzle array 67 of the ink heads is an array extending longitudinally. In this example, the longitudinal length L5 of the modeling nozzle array 65 is preferably equal or substantially equal to the longitudinal length L6 of the ink nozzle array 67. Alternatively, the length L5 of the modeling nozzle array 65 may be larger or smaller than the length L6 of the ink nozzle array 67. The length L5 of the modeling nozzle array 65 and the length L6 of the ink nozzle array 67 are preferably less than or equal to the length L1 of the modeling space 21. The length L5 of the modeling nozzle array 65 and the length L6 of the ink nozzle array 67 are preferably larger than the longitudinal length of a three-dimensional object 3 to be modeled. The length L5 of the modeling nozzle array 65 and the length L6 of the ink nozzle array 67 are preferably less than or equal to the length L2 of the surplus space 31. Although not shown, the length L5 of the modeling nozzle array 65 and the length L6 of the ink nozzle array 67 are preferably greater than or equal to the length L3 of the supply port 46 (see FIG. 1). Alternatively, the length L5 and the length L6 may be smaller than the length L3 of the supply port 46. The length L5 of the modeling nozzle array 65 and the length L6 of the ink nozzle array 67 are preferably less than or equal to the length L4 of the filling roller 50 (see FIG. 1). Alternatively, the length L5 and the length L6 may be larger than the length L4 of the filling roller 50. In the present preferred embodiment, the lengths L5 and L6 of the nozzle arrays 65 and 67 refer to effective nozzle array lengths. The “effective nozzle array length” refers to a range of an allowable length of a nozzle array in a line head.

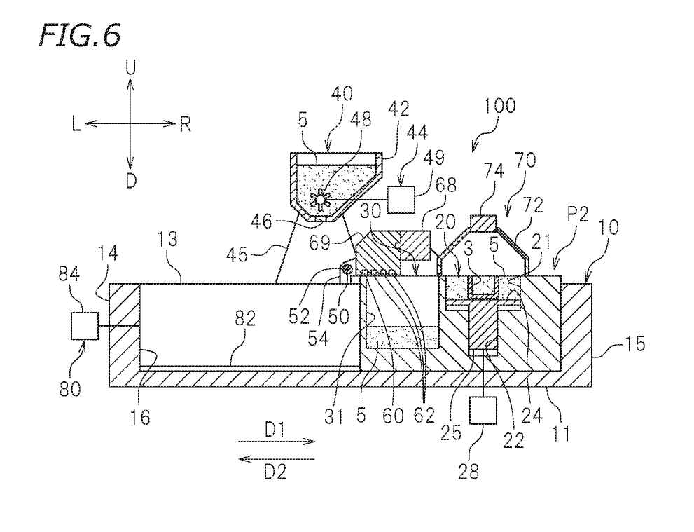

As illustrated in FIG. 3, the heater 70 applies heat to the powder material 5 in the modeling space 21 of the modeling tank 20. In other words, the heater 70 dries a portion of the powder material 5 which is housed in the modeling space 21 and to which the curing liquid is applied. The heater 70 is disposed above the modeling movement space 16 of the body 10. The heater 70 is disposed downstream of the powder supplier 40, the filling roller 50, the modeling head 60, and the ink heads 62. The heater 70 is not limited to a specific configuration. In the present preferred embodiment, the heater 70 preferably includes a cover 72 and a microwave irradiator 74. FIG. 6 is a front cross-sectional view of the three-dimensional modeling apparatus 100. FIG. 6 is a view illustrating a state in which the modeling tank 20 is located below the heater 70. As illustrated in FIG. 6, the cover covers the modeling tank 20 while the modeling tank 20 is located below the heater 70. The cover 72 defines and functions as a shield against microwaves. The cover 72 prevents diffusion of high-temperature steam generated by drying of the powder material 5 to which the curing liquid is applied. The microwave irradiator 74 generates microwaves in the cover 72. The microwave irradiator 74 applies microwaves to the powder material 5 in the modeling space 21 while the modeling tank 20 is located below the heater 70. The microwave irradiator 74 is disposed inside the cover 72.

In the present preferred embodiment, as illustrated in FIG. 1, in plan view, the modeling tank 20, the modeling table 24 (see FIG. 3), the surplus powder container 30, the supply port 46 of the powder supplier 40, the filling roller 50, the head case 69 (specifically the modeling head 60 (see FIG. 5) and the plurality of ink heads 62 (see FIG. 5)), and the heater 70 are disposed on the predetermined line L10 extending laterally. The line L10 is a line disposed on the modeling movement space 16 of the body 10 in plan view. In plan view, the modeling tank 20, the modeling table 24, the surplus powder container 30, the supply port 46 of the powder supplier 40, the filling roller 50, the modeling head 60, the plurality of ink heads 62, and the heater 70 are arranged in the lateral direction.

As illustrated in FIG. 3, the conveyor 80 moves the modeling tank 20 laterally, that is, in the forward direction D1 and the backward direction D2, relative to the powder supplier 40, the filling roller 50, the modeling head 60, the ink heads 62, and the heater 70. In the present preferred embodiment, the conveyor 80 moves the modeling tank 20 laterally in the modeling movement space 16 so as to move the modeling tank 20 relative to the powder supplier 40, the filling roller 50, the modeling head 60, the ink heads 62, and the heater 70. The conveyor 80 moves the surplus powder container 30 together with the modeling tank 20 laterally. In the present preferred embodiment, the conveyor 80 moves the modeling tank 20 in the forward direction D1 and the backward direction D2. Alternatively, the conveyor 80 may move the modeling tank 20 in the forward direction D1 but not to move the modeling tank 20 in the backward direction D2. In this case, movement of the modeling tank 20 in the backward direction D2 is manually performed. The conveyor 80 is not limited to a specific configuration. In the present preferred embodiment, the conveyor 80 includes guide rails 82 and a second driving motor 84.

The guide rails 82 guide lateral movement of the modeling tank 20 and the surplus powder container 30. In the present preferred embodiment, as illustrated in FIG. 1, two guide rails 82, for example, are preferably disposed on the bottom wall 11 of the body 10. The guide rails 82 are not limited to a specific location and a specific number. For example, the guide rails 82 may be disposed on the front surface of the rear wall 13 of the body 10. The guide rails 82 may be disposed on the rear surface of the front wall 12 of the body 10. The number of the guide rails 82 may be one, or three or more. As illustrated in FIG. 3, the guide rails 82 extend laterally. In the present preferred embodiment, the modeling tank 20 and the surplus powder container 30 are slidably disposed on the guide rails 82. Accordingly, the modeling tank 20 and the surplus powder container 30 is able to move in the forward direction D1 and the backward direction D2 along the guide rails 82. The second driving motor 84 is electrically connected to the modeling tank 20 through the surplus powder container 30. When the second driving motor 84 is driven, the modeling tank 20 and the surplus powder container 30 are moved together in the forward direction D1 and the backward direction D2.

FIG. 7 is a block diagram of the three-dimensional modeling apparatus 100. As illustrated in FIG. 7, the controller 90 is configured or programmed to control modeling of a three-dimensional object 3 in the modeling tank 20. The controller 90 is not limited to a specific configuration. The controller 90 is preferably defined by, for example, a microcomputer. The controller 90 includes a central processing unit (CPU) and a ROM storing, for example, a program or programs to be executed by the CPU, a RAM, and so forth. In this example, the controller 90 performs control of modeling by using a program or programs stored in the microcomputer. In the present preferred embodiment, the controller 90 is disposed inside the body 10.

In the present preferred embodiment, the controller 90 is connected to the elevator 28, the first driving motor 49 of the feeder 44 of the powder supplier 40, the modeling head 60, the ink heads 62, the microwave irradiator 74 of the heater 70, and the second driving motor 84 of the conveyor 80 so as to enable communication therebetween. The controller 90 is configured or programmed to control the elevator 28, the first driving motor 49, the modeling head 60, the ink heads 62, the microwave irradiator 74, and the second driving motor 84. The controller 90 controls the elevator 28 to thus control vertical movement of the modeling table 24 in the modeling tank 20. The controller 90 controls driving of the first driving motor 49 to control rotation of the rotary valve 48, thus controlling the supply amount of the powder material 5 in the supply vessel 42 (see FIG. 3) to the modeling tank 20. The controller 90 controls the timing of discharging the curing liquid from the modeling head 60 and the amount of the curing liquid. The controller 90 controls the timing of discharging ink from the ink heads 62 and the amount of the ink. The controller 90 controls the microwave irradiator 74 to thus control the timing and intensity of application of microwaves, for example. The controller 90 controls driving of the second driving motor 84 to thus control movement of the modeling tank 20 and the surplus powder container 30 in the forward direction D1 and the backward direction D2.

In the present preferred embodiment, the controller 90 is configured or programmed to include a memory 91, a lifting controller 92, a movement controller 93, a supply controller 94, a discharge controller 95, and a heating controller 96. Each of the controllers 91, 92, 93, 94, 95 and 96 of the controller 90 is preferably implemented by a program or programs. The program(s) is read from a recording medium such as a CD or a DVD, for example. The program(s) may be downloaded through the Internet. Each of the controllers 91, 92, 93, 94, 95 and 96 of the controller 90 may be implemented by a processor or a circuit, for example. In a case in which each of the controllers 91, 92, 93, 94, 95 and 96 is implemented by a processor, the controllers 91, 92, 93, 94, 95 and 96 may be implemented by one processor or may be implemented by a plurality of processors.

The memory 91 stores cross-section images obtained by slicing a three-dimensional object 3 to be modeled into a plurality of layers continuous in a predetermined direction (e.g., horizontal direction). The lifting controller 92 controls the elevator 28 so as to lift and lower the modeling table 24 in the modeling space 21 of the modeling tank 20. In this example, the lifting controller 92 controls the elevator 28 so as to lower the modeling table 24 to a distance corresponding to a predetermined thickness (e.g., about 0.1 mm) of a powder cured layer to be modeled.

The movement controller 93 controls the conveyor 80 so as to move the modeling tank 20 from a start position P1 (see FIG. 3) to a stop position P2 (see FIG. 6). As illustrated in FIG. 3, the start position P1 refers to a position in the modeling movement space 16 of the body 10 upstream of the supply port 46 of the powder supplier 40, the filling roller 50, and the modeling head 60. In the present preferred embodiment, the start position P1 refers to a position of the modeling tank 20 in a state in which the modeling tank 20 is located at the most upstream position in the modeling movement space 16. As illustrated in FIG. 6, the stop position P2 refers to a position in the modeling movement space 16 downstream of the supply port 46 of the powder supplier 40, the filling roller 50, and the modeling head 60. In the present preferred embodiment, the stop position P2 refers to a position of the modeling tank 20 in a state where the modeling tank 20 is located at the most downstream position in the modeling movement space 16. The stop position P2 refers to a position of the modeling tank 20 in a state in which the modeling tank 20 is disposed below the heater 70. In the present preferred embodiment, the movement controller 93 causes the surplus powder container 30 to move together with the modeling tank 20 from an upstream side to a downstream side, that is, in the forward direction D1. The movement controller 93 controls the conveyor 80 to prevent the modeling tank 20 from stopping while the modeling tank 20 moves from the start position P1 to the stop position P2. The movement controller 93 controls the conveyor 80 so as to cause the modeling tank 20 and the surplus powder container 30 to move from the stop position P2 to the start position P1, that is, in the backward direction D2.

As illustrated in FIG. 4, the supply controller 94 controls driving of the first driving motor 49 of the feeder 44 so as to supply the powder material 5 from the supply port 46 to the modeling tank 20 while the modeling tank 20 is passing below the supply port 46 of the powder supplier 40. The discharge controller 95 causes the modeling head 60 to discharge the curing liquid while the modeling tank 20 is passing below the modeling head 60. At this time, the discharge controller 95 causes the modeling head 60 to discharge the curing liquid in conformity with the shape of the cross-section image stored in the memory 91. In the present preferred embodiment, the discharge controller 95 causes the plurality of ink heads 62 to discharge ink while the modeling tank 20 is passing below the plurality of ink heads 62. At this time, the discharge controller 95 causes the plurality of ink heads 62 to discharge ink based on color information of the cross-section image stored in the memory 91. As illustrated in FIG. 6, the heating controller 96 controls the microwave irradiator 74 so that the microwave irradiator 74 applies heat to the powder material 5 housed in the modeling space 21 of the modeling tank 20 while the modeling tank 20 is located below the heater 70, that is, the cover 72 of the heater 70.

The foregoing description has been directed to the three-dimensional modeling apparatus 100. Next, an operation of the three-dimensional modeling apparatus 100 in modeling a three-dimensional object 3 will be described. In the present preferred embodiment, a desired three-dimensional object 3 is modeled by sequentially stacking powder cured layers conforming to the cross-section image showing a cross-sectional shape of the desired three-dimensional object 3.

In the present preferred embodiment, as illustrated in FIG. 3, at the start of modeling, the modeling tank 20 is located at the start position P1 in the modeling movement space 16. In this state, the lifting controller 92 lowers the modeling table 24 to a distance corresponding to the thickness of powder cured layers to be modeled. Accordingly, a space having a height corresponding to the thickness of the powder cured layers is provided above the modeling table 24. Thereafter, the movement controller 93 moves the modeling tank 20 and the surplus powder container 30 from the start position P1 to the stop position P2. At this time, the movement controller 93 controls the conveyor 80 to prevent the modeling tank 20 and the surplus powder container 30 from stopping in the middle of the movement. The modeling tank 20 does not stop while the powder material 5 is supplied from the powder supplier to the modeling tank 20. While the modeling head 60 is discharging the curing liquid, the modeling tank 20 does not stop. While the plurality of ink heads 62 are discharging the ink, the modeling tank 20 does not stop.

In the present preferred embodiment, as illustrated in FIG. 4, while the modeling tank 20 moves from the start position P1 to the stop position P2, supply of the powder material 5, filling with the powder material 5, and discharge of the curing liquid and the ink are performed. For example, while the modeling tank 20 passes below the supply port 46 of the powder supplier 40, the supply controller 94 drives the first driving motor 49 to cause the rotary valve 48 to rotate so that the powder material 5 in the supply vessel 42 is supplied from the supply port 46 to the modeling space 21 of the modeling tank 20. Subsequently, while the modeling tank 20 is moving downstream, a portion of the modeling space 21 located above the modeling table 24 is filled with the powder material 5 by the filling roller 50. At this time, while the filling roller 50 is rotating, the filling roller 50 causes the powder material 5 to fill the space. A portion of the powder material 5 removed by the filling roller 50 from the space above the modeling table 24 is housed in the surplus powder container 30 while being pushed by the filling roller 50.

In the manner described above, after filling with the powder material 5 by the filling roller 50, the portion of the modeling tank 20 filled with the powder material 5 passes below the modeling head 60 and the plurality of ink heads 62. At this time, based on the cross-section image stored in the memory 91, the discharge controller 95 causes the modeling head 60 to discharge the curing liquid and the plurality of ink heads 62 to discharge the ink. Accordingly, powder cured layers based on the cross-section image are modeled.

Thereafter, as illustrated in FIG. 6, the modeling tank 20 moves to the stop position P2 so as to be located below the cover 72 of the heater 70. At this time, the heating controller 96 controls the microwave irradiator 74 in order to cure a portion of the powder material 5 in the modeling space 21 to which the curing liquid is discharged. Through the foregoing operations, formation of a single powder cured layer is completed. Thereafter, the movement controller 93 controls the conveyor 80 to cause the modeling tank 20 to move from the stop position P2 to the start position P1, that is, in the backward direction D2. Once the modeling tank 20 has reached the start position P1, the operations described above are sequentially performed, thus forming a next powder cured layer. In this manner, powder cured layers are sequentially stacked so that a desired three-dimensional object 3 is modeled.

As described above, in the present preferred embodiment, while the conveyor 80 moves the modeling tank 20 from the upstream side to the downstream side, supply of the powder material 5 from the powder supplier 40, filling the modeling space 21 with the powder material 5 by the filling roller 50, and discharge of the curing liquid from the modeling head 60 are sequentially performed. In this example, as illustrated in FIG. 4, even before the supply of the powder material 5 to the modeling tank 20 by the powder supplier 40 is completely finished, filling with the powder material 5 by the filling roller 50 is sequentially performed from a portion of the modeling space 21 of the modeling tank 20 supplied with the powder material 5. Even before filling of the modeling space 21 with the powder material 5 by the filling roller 50 is completely finished, discharge of the curing liquid from the modeling head 60 is sequentially performed from a portion of the modeling space 21 in which filling which the powder material 5 is completed. Thus, the time required to model a three-dimensional object 3 is reduced, as compared to a three-dimensional modeling apparatus in which the process of supplying the powder material 5, the process of filling with the powder material 5, and the process of discharging the curing liquid are completely separate and performed independently.

In the present preferred embodiment, as illustrated in FIG. 1, in plan view, the modeling tank 20, the modeling table 24 (see FIG. 3), the surplus powder container 30, the supply port 46 of the powder supplier 40, the filling roller 50, the modeling head 60, the plurality of ink heads 62, and the heater 70 are preferably disposed on the predetermined line L10 extending laterally above the modeling movement space 16. Accordingly, a single powder cured layer is able to be modeled only by moving the modeling tank 20 linearly from the upstream side to the downstream side in the lateral direction once. Thus, a three-dimensional object 3 is able to be modeled without control in two dimensions. As a result, it is possible to reduce or prevent complex control in modeling a three-dimensional object 3.

In the present preferred embodiment, as illustrated in FIG. 3, in the body 10, the modeling tank 20 is movably housed in the modeling movement space 16 extending laterally. The supply port 46 of the powder supplier 40, the filling roller 50, the modeling head 60, the plurality of ink heads 62, and the heater 70 are disposed above the modeling movement space 16. Accordingly, the modeling tank 20 moves from the upstream side to the downstream side in the modeling movement space 16 extending laterally. Thus, the modeling movement space 16 restricts the direction of movement of the modeling tank 20. This ensures movement of the modeling tank 20 from the upstream side to the downstream side. In the present preferred embodiment, the conveyor 80 moves the modeling tank 20. Positions of the supply port 46 of the powder supplier 40, the filling roller 50, the modeling head 60, the plurality of ink heads 62, and the heater 70 are fixed relative to the body 10. Thus, it is easy to control movement of the modeling tank 20 relative to the supply port 46 of the powder supplier 40, the filling roller 50, the modeling head 60, the plurality of ink heads 62, and the heater 70.

In the present preferred embodiment, the movement controller 93 of the controller 90 controls the conveyor 80 to prevent the modeling tank 20 from stopping while the modeling tank 20 moves from the start position P1 (see FIG. 3) to the stop position P2 (see FIG. 6). As described above, a three-dimensional object 3 is able to be modeled while the modeling tank 20 is moving from the upstream side to the downstream side without stopping. Thus, the time required to model the three-dimensional object 3 is further reduced. In addition, while the modeling tank 20 is moving from the upstream side to the downstream side, driving and stopping of the second driving motor 84 of the conveyor 80 are not alternately performed. Thus, power consumption of the conveyor 80 is reduced.

In the present preferred embodiment, as illustrated in FIG. 4, when the modeling tank 20 moves to be located below the supply port 46 of the powder supplier 40, the supply controller 94 causes the powder supplier 40 to supply the powder material 5 to the modeling tank 20. When the modeling tank 20 moves to be located below the modeling head 60, the discharge controller 95 causes the modeling head 60 to discharge the curing liquid. When the modeling tank 20 moves to be located below the plurality of ink heads 62, the discharge controller 95 causes the plurality of ink heads 62 to discharge the ink. In this manner, during the movement of the modeling tank 20 from the upstream side to the downstream side, that is, movement in the forward direction D1, supply of the powder material 5, discharge of the curing liquid, and discharge of the ink are able to be performed. Accordingly, powder cured layers are able to be efficiently provided. By stacking such powder cured layers, a three-dimensional object 3 is able to be efficiently modeled.

In the present preferred embodiment, as illustrated in FIG. 1, the longitudinal length L3 of the supply port 46 is preferably less than or equal to the longitudinal length L1 of the modeling space 21 of the modeling tank 20. The length L3 of the supply port 46 is preferably within a range in the longitudinal direction in which the powder material 5 is supplied. Thus, the powder material 5 supplied from the supply port 46 is less likely to be supplied outside of the modeling space 21.

In the present preferred embodiment, as illustrated in FIG. 5, the longitudinal length L5 of the modeling nozzle array 65 of the modeling head 60 and the longitudinal length L6 of the ink nozzle array 67 of the ink heads 62 are preferably less than or equal to the longitudinal length L1 of the modeling space 21. The length L5 of the modeling nozzle array 65 is preferably within a range in the longitudinal direction in which the curing liquid can be discharged. Thus, the curing liquid from the modeling head 60 is less likely to be discharged outside of the modeling space 21. The length L6 of the ink nozzle array 67 is preferably within a range in the longitudinal direction in which the ink is able to be discharged. Thus, the ink from the ink heads 62 is less likely to be discharged outside of the modeling space 21.

In the present preferred embodiment, as illustrated in FIG. 4, the filling roller 50 is a roller that is rotatable about the rotating shaft 52 extending longitudinally. Accordingly, the modeling space 21 of the modeling tank 20 is able to be filled with the powder material 5 while the filling roller 50 is rotating. As a result, a flatter surface is able to be provided at the upper-layer surface of the modeling space 21.

In the present preferred embodiment, as illustrated in FIG. 1, the longitudinal length L4 of the filling roller 50 is preferably greater than or equal to the longitudinal length L1 of the modeling space 21. This configuration ensures passage of the filling roller 50 over the upper-layer surface of the modeling space 21. Accordingly, the filling roller 50 prevents the presence of an upper-layer portion of the modeling space 21 that is not filled with the powder material 5.

In the present preferred embodiment, the surplus powder container 30 is disposed upstream of the modeling tank 20. The modeling tank 20 moves from the upstream side to the downstream side together with the surplus powder container 30. Accordingly, the powder material 5 removed from the modeling tank 20 by the filling roller 50 is housed in the surplus powder container 30. Thus, it is possible to prevent scattering of a surplus powder material around the three-dimensional modeling apparatus 100.

In the present preferred embodiment, the heater 70 is disposed downstream of the modeling head 60. Accordingly, a portion of the powder material 5 which is housed in the modeling tank 20 and to which the curing liquid is discharged is able to be efficiently dried by the heater 70.

The foregoing description is directed to the three-dimensional modeling apparatus 100 according to the first preferred embodiment. Three-dimensional modeling apparatuses according to preferred embodiments of the present invention are not limited to the three-dimensional modeling apparatus 100 according to the first preferred embodiment, and may be implemented in other various preferred embodiments. Next, other preferred embodiments of the present invention will be briefly described. In the following description, elements already described above are denoted by the same reference characters, and description will be omitted as appropriate.

### Second Preferred Embodiment

Next, a three-dimensional modeling apparatus 200 according to a second preferred embodiment of the present invention will be described. In the first preferred embodiment, as illustrated in FIG. 4, while the modeling tank 20 moves from the upstream side to the downstream side, that is, moves in the forward direction D1, the powder material 5 is supplied, and the modeling space 21 is filled with the powder material 5, and the curing liquid and the ink are discharged to the powder material 5. That is, in the first preferred embodiment, modeling of a three-dimensional object 3 is performed while the modeling tank 20 moves from the upstream side to the downstream side. On the other hand, in the three-dimensional modeling apparatus 200 according to the second preferred embodiment, while a modeling tank 20 moves from an upstream side to a downstream side and while the modeling tank 20 moves from the downstream side to the upstream side, modeling of a three-dimensional object 3 is performed. That is, modeling of the three-dimensional object 3 is performed while the modeling tank 20 moves in both of a forward direction D1 and a backward direction D2.

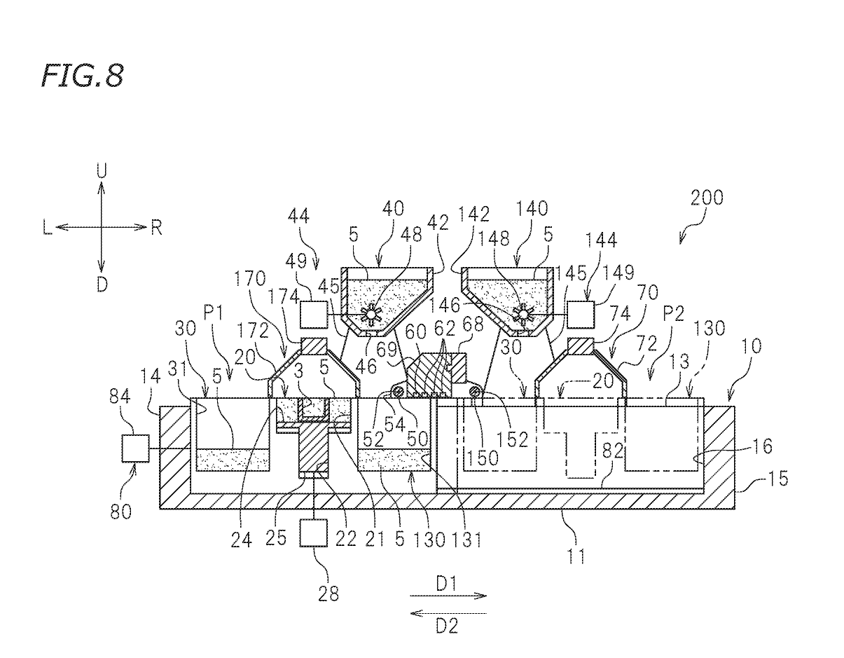

FIG. 8 is a front cross-sectional view of the three-dimensional modeling apparatus 200 according to the second preferred embodiment. As illustrated in FIG. 8, in a manner similar to the three-dimensional modeling apparatus 100 according to the first preferred embodiment, the three-dimensional modeling apparatus 200 includes a body 10, a modeling tank 20 including a modeling space 21, a modeling table 24, an elevator 28, a surplus powder container 30 including a surplus space 31, a powder supplier 40, a filling roller 50, a modeling head 60, a plurality of ink heads 62, a conveyor 80, and a controller 90 (see FIG. 7). In the present preferred embodiment, the three-dimensional modeling apparatus 200 further includes another surplus powder container 130, another powder supplier 140, another filling roller 150, and another heater 170.

In the present preferred embodiment, the surplus powder container 130 houses a powder material 5 removed from the modeling tank 20 by the filling roller 150. The surplus powder container 130 includes a surplus space 131 that houses the powder material 5. The surplus powder container 130 is disposed downstream of the modeling tank 20 in a modeling movement space 16 of the body 10. The surplus powder container 130 is movable laterally by the conveyor 80 together with the modeling tank 20 and the surplus powder container 30.

In the present preferred embodiment, the powder supplier 140 supplies the powder material 5 to the modeling tank 20. The powder supplier 140 preferably has a configuration similar to that of the powder supplier 40, and thus, will not be specifically described here. In the present preferred embodiment, the powder supplier 140 includes a supply vessel 142 including a supply port 146 and a feeder 144. The feeder 144 includes a rotary valve 148 and a driving motor 149. The supply vessel 142 is supported by a supply support 145 extending upward from the body 10. In the present preferred embodiment, the supply port 146 of the powder supplier 140 corresponds to a “second supply port”. In the present preferred embodiment, the supply port 146 of the powder supplier 140 is disposed downstream of the modeling head 60 and the ink heads 62. In the present preferred embodiment, the supply port 146 of the powder supplier 140 is disposed downstream of the powder supplier 40 and the filling roller 50, and upstream of a heater 70. The supply port 146 of the powder supplier 140 is disposed above the modeling movement space 16 of the body 10.

The filling roller 150 fills the modeling space 21 of the modeling tank 20 with the powder material 5 supplied from the powder supplier 140. The filling roller 150 is disposed between the modeling head 60 and the supply port 146 of the powder supplier 140 in plan view. In the present preferred embodiment, the filling roller 150 is disposed downstream of the powder supplier 40, the filling roller 50, the modeling head 60, and the plurality of ink heads 62, and upstream of the supply port 146 of the powder supplier 140. The filling roller 150 is disposed upstream of the heater 70. The filling roller 150 is disposed above the modeling movement space 16 of the body 10. In the present preferred embodiment, the filling roller 150 preferably has a configuration similar to that of the filling roller 50. The filling roller 150 includes a rotating shaft 152 extending longitudinally. The filling roller 150 is supported to be rotatable relative to the body 10.

The heater 170 applies heat to the powder material 5 in the modeling tank 20. In the present preferred embodiment, the heater 170 is disposed upstream of the powder supplier 40, the filling roller 50, the modeling head 60, the plurality of ink heads 62, the heater 70, the powder supplier 140, and the filling roller 150. The heater 170 is disposed above the modeling movement space 16 of the body 10. In the present preferred embodiment, the heater 170 preferably has a configuration similar to that of the heater 70. The heater 170 includes a cover 172 and a microwave irradiator 174 disposed in the cover 172.

In plan view, the modeling tank 20, the modeling table 24, the surplus powder container 30, the powder supplier 40, the filling roller 50, the modeling head 60, the plurality of ink heads 62, the heater 70, the surplus powder container 130, the powder supplier 140, the filling roller 150, and the heater 170 extend laterally, and are located on a line disposed above the modeling movement space 16. In other words, in plan view, the modeling tank 20, the modeling table 24, the surplus powder container 30, the powder supplier 40, the filling roller 50, the modeling head 60, the plurality of ink heads 62, the heater 70, the surplus powder container 130, the powder supplier 140, the filling roller 150, and the heater 170 are arranged laterally.

In the present preferred embodiment, the conveyor 80 moves the modeling tank 20 from a start position P1 to a stop position P2 and from the stop position P2 to the start position P1. That is, the conveyor 80 moves the modeling tank 20 in the forward direction D1 and in the backward direction D2.

In the present preferred embodiment, while a movement controller 93 illustrated in FIG. 7 moves the modeling tank 20 from the start position P1 to the stop position P2, the powder supplier 40 supplies the powder material 5, and the filling roller fills the space with the powder material 5. Thereafter, a curing liquid is discharged from the modeling head 60, and ink is discharged from the plurality of ink heads 62, thus modeling a powder cured layer. Then, after the modeling tank 20 has reached the stop position P2, the heater 70 applies heat to the powder material 5 in the modeling space 21 of the modeling tank 20.

In the foregoing manner, after a single powder cured layer is formed, the movement controller 93 moves the modeling tank 20 from the stop position P2 to the start position P1. While the modeling tank 20 moves from the stop position P2 to the start position P1, a next powder cured layer is formed. At this time, first, while the modeling tank 20 moves to the backward direction D2, the powder supplier 140 supplies the powder material 5 to the modeling space 21 of the modeling tank 20. Then, the modeling space 21 is filled with the powder material 5 by the filling roller 150. At this time, the powder material 5 removed by the filling roller 150 is pushed by the filling roller 150, and is housed in the surplus space 131 of the surplus powder container 130. Thereafter, the curing liquid is discharged from the modeling head 60, and the ink is discharged from the plurality of ink heads 62, thus forming a next powder cured layer. Subsequently, after the modeling tank 20 has reached the start position P1, the heater 170 applies heat to the powder material 5 in the modeling space 21.

In the manner described above, in the present preferred embodiment, a powder cured layer is formed while the modeling tank 20 moves from the upstream side to the downstream side. A powder cured layer is also formed while the modeling tank 20 moves from the downstream side to the upstream side. Accordingly, powder cured layers are able to be more efficiently formed. As a result, the time required to model a three-dimensional object 3 is reduced.

### Third Preferred Embodiment

A three-dimensional modeling apparatus 300 according to a third preferred embodiment of the present invention will be described. In the present preferred embodiment, in a manner similar to that of the second preferred embodiment, the three-dimensional modeling apparatus 300 is able to model a three-dimensional object 3 while a modeling tank 20 moves from an upstream side to a downstream side and while the modeling tank 20 moves from the downstream side to the upstream side.

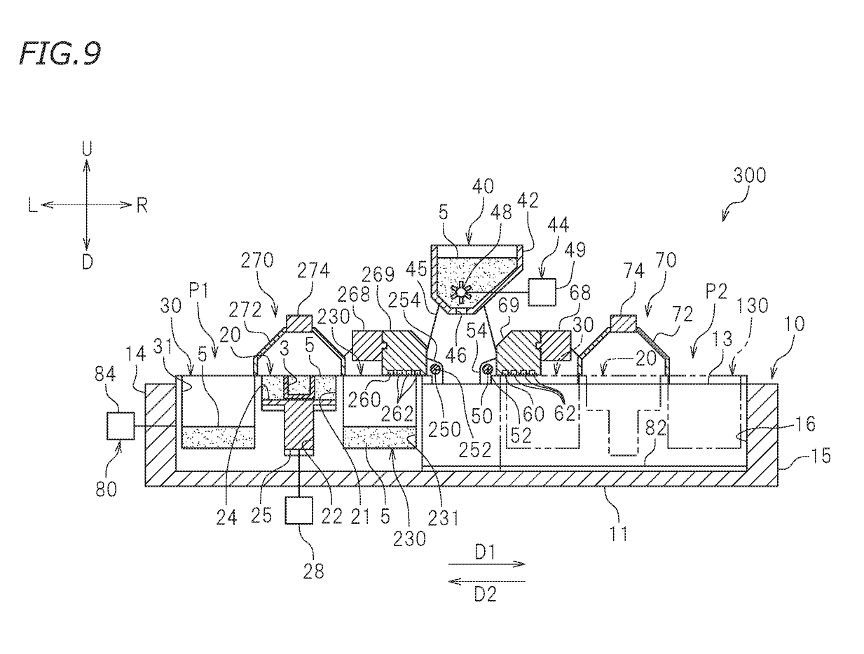

FIG. 9 is a front cross-sectional view of the three-dimensional modeling apparatus 300 according to the third preferred embodiment. As illustrated in FIG. 9, the three-dimensional modeling apparatus 300 includes a body 10, a modeling tank 20 including a modeling space 21, a modeling table 24, an elevator 28, a surplus powder container 30 including a surplus space 31, a powder supplier 40, a filling roller 50, a modeling head 60, a plurality of ink heads 62, a conveyor 80, and a controller 90 (see FIG. 7). In the present preferred embodiment, the three-dimensional modeling apparatus 300 further includes another surplus powder container 230, another filling roller 250, another modeling head 260, a plurality of other ink heads 262, and another heater 270.

In the present preferred embodiment, the surplus powder container 230 preferably has a configuration similar to the surplus powder container 130 according to the second preferred embodiment, and houses a powder material 5 removed from the modeling space 21 of the modeling tank 20 by the filling roller 250. The surplus powder container 230 includes a surplus space 231 that houses the powder material 5. The surplus powder container 230 is disposed downstream of the modeling tank 20. The surplus powder container 230 is movable laterally by the conveyor 80 together with the modeling tank 20 and the surplus powder container 30.

The filling roller 250 fills the modeling space 21 of the modeling tank 20 with the powder material 5 supplied from the powder supplier 40. The filling roller 250 is disposed upstream of a supply port 46 of the powder supplier 40. In the present preferred embodiment, the filling roller 250 is disposed upstream of the filling roller 50, the modeling head 60, the plurality of ink heads 62, and the heater 70. The filling roller 250 is disposed above a modeling movement space 16 of the body 10. The filling roller 250 preferably has a configuration similar to that of the filling roller 50. That is, the filling roller 250 includes a rotating shaft 252 extending longitudinally. The filling roller 250 is supported to be rotatable relative to the body 10.

The modeling head 260 discharges a curing liquid to the powder material 5 placed on the modeling table 24. The plurality of ink heads 262 discharge ink to the powder material 5 placed on the modeling table 24. The modeling head 260 and the plurality of ink heads 262 are provided in a head case 269 disposed above modeling movement space 16. A support 254 is disposed on the upper surface of the body 10. The support 254 supports a head bridge 268 disposed above the modeling movement space 16. The head case 269 is disposed on the head bridge 268. In the present preferred embodiment, the modeling head 260 and the plurality of ink heads 262 are disposed upstream of the filling roller 250. The modeling head 260 and the plurality of ink heads 262 are disposed upstream of the powder supplier 40, the filling roller 50, the modeling head 60, the plurality of ink heads 62, and the heater 70. The modeling head 260 is disposed upstream of the plurality of ink heads 262. Alternatively, the modeling head 260 may be disposed downstream of the plurality of ink heads 262. In the present preferred embodiment, the modeling head 260 preferably has a configuration similar to that of the modeling head 60. The plurality of ink heads preferably 262 have configurations similar to those of the plurality of ink heads 62. A plurality of modeling nozzles 64 (see FIG. 5) are provided in the modeling head 260 and arranged longitudinally. A plurality of ink nozzles 66 (see FIG. 5) arranged longitudinally are provided in each of the ink heads 262.

The heater 270 applies heat to the powder material 5 in the modeling space 21 of the modeling tank 20. In the present preferred embodiment, the heater 270 is disposed upstream of the powder supplier 40, the filling roller 50, the modeling head 60, the plurality of ink heads 62, the heater 70, the filling roller 250, the modeling head 260, and the plurality of ink heads 262. The heater 270 is disposed above the modeling movement space 16 of the body 10. In the present preferred embodiment, the heater 270 preferably has a configuration similar to that of the heater 70, and includes a cover 272 and a microwave irradiator 274.

In the present preferred embodiment, in plan view, the modeling tank 20, the modeling table 24, the surplus powder container 30, the powder supplier 40, the filling roller 50, the modeling head 60, the plurality of ink heads 62, the heater 70, and the surplus powder container 230, the filling roller 250, the modeling head 260, the plurality of ink heads 262, and the heater 270 extend laterally, and are located on a line disposed above the modeling movement space 16. In other words, in plan view, the modeling tank 20, the modeling table 24, the surplus powder container 30, the powder supplier 40, the filling roller 50, the modeling head 60, the plurality of ink heads 62, the heater 70, the surplus powder container 230, the filling roller 250, the modeling head 260, the plurality of ink heads 262, and the heater 270 are arranged laterally.

In the present preferred embodiment, while a movement controller 93 illustrated in FIG. 7 moves the modeling tank 20 from a start position P1 to a stop position P2, the powder supplier 40 supplies the powder material 5. Then, the space is filled with the powder material 5 by the filling roller 50. Thereafter, a curing liquid is discharged from the modeling head 60, and ink is discharged from the plurality of ink heads 62, thus modeling a powder cured layer. Then, after the modeling tank 20 has reached the stop position P2, the heater 70 applies heat to the powder material 5 in the modeling space 21 of the modeling tank 20.

In the foregoing manner, after a single powder cured layer is formed, the movement controller 93 moves the modeling tank 20 from the stop position P2 to the start position P1. While the modeling tank 20 moves from the stop position P2 to the start position P1, a next powder cured layer is formed. At this time, first, while the modeling tank 20 moves in the backward direction D2, the powder supplier 40 supplies the powder material 5 to the modeling space 21 of the modeling tank 20. Then, the modeling space 21 is filled with the powder material 5 by the filling roller 250. At this time, the powder material 5 removed by the filling roller 250 is pushed by the filling roller 250, and is housed in the surplus space 231 of the surplus powder container 230. Thereafter, the curing liquid is discharged from the modeling head 260, and the ink is discharged from the plurality of ink heads 262, thereby forming a next powder cured layer. Subsequently, after the modeling tank 20 has reached the start position P1, the heater 270 applies heat to the powder material 5 in the modeling space 21.

As described above, in the present preferred embodiment, in a manner similar to the second preferred embodiment, while the modeling tank 20 moves from the upstream side to the downstream side, and while the modeling tank 20 moves from the downstream side to the upstream side, powder cured layers are also formed. Accordingly, powder cured layers are able to be more efficiently formed. As a result, the time required to model a three-dimensional object 3 is reduced.

### Fourth Preferred Embodiment

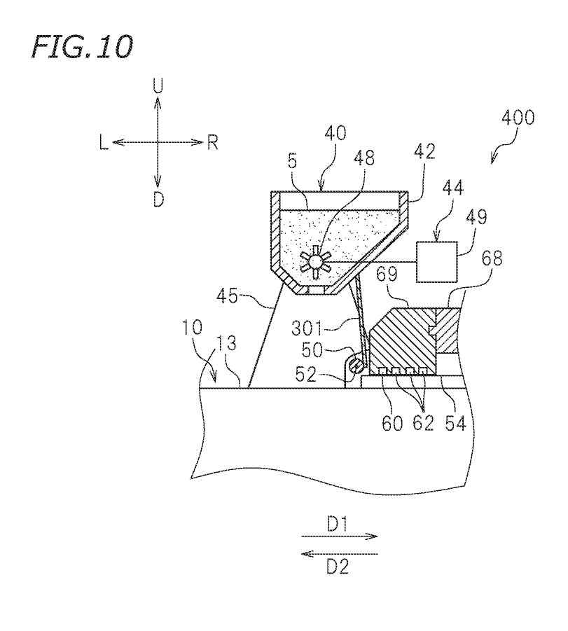

A three-dimensional modeling apparatus 400 according to a fourth preferred embodiment of the present invention will be described. FIG. 10 is a front cross-sectional view of the three-dimensional modeling apparatus 400 according to the fourth preferred embodiment in a partially enlarged manner. The three-dimensional modeling apparatus 400 according to the present preferred embodiment has a configuration similar to that of the three-dimensional modeling apparatus 100 according to the first preferred embodiment. The three-dimensional modeling apparatus 400 includes a body 10, a modeling tank 20 including a modeling space 21, a modeling table 24, an elevator 28, a surplus powder container 30 including a surplus space 31, a powder supplier 40, a filling roller 50, a modeling head 60, a plurality of ink heads 62, a conveyor 80, and a controller 90. In the present preferred embodiment, as illustrated in FIG. 10, the three-dimensional modeling apparatus 400 further includes a powder reconveyor 301.

The powder reconveyor 301 removes the powder material 5 attached to the filling roller 50 from the filling roller 50. In the present preferred embodiment, the powder reconveyor 301 is also able to remove the powder material 5 near the filling roller 50. The “the powder material near the filling roller 50” here refers to, for example, the powder material 5 floating around the filling roller 50. The powder reconveyor 301 is disposed to be able to contact the filling roller 50. The filling roller 50 is not limited to a specific position and a specific shape. In the present preferred embodiment, the powder reconveyor 301 is disposed in a supply vessel 42 of the powder supplier 40. The powder reconveyor 301 is preferably a plate-shaped member extending rightward and downward from the right surface of the supply vessel 42 towards the filling roller 50. The lower end of the powder reconveyor 301 is able to contact the filling roller 50. The lower end of the powder reconveyor 301 may be provided with a brush or a rubber member.

In the present preferred embodiment, when filling the modeling space 21 of the modeling tank 20 with the powder material 5 by the filling roller 50, the filling roller 50 rotates about a rotating shaft 52. At this time, the filling roller 50 rotates with the powder material 5 being attached to the filling roller 50 in some cases. In the present preferred embodiment, when the filling roller 50 rotates and the powder material 5 attached to the filling roller 50 reaches a lower end portion of the powder reconveyor 301, the powder material 5 is removed by the powder reconveyor 301. Thus, the powder material 5 attached to the filling roller 50 is removed.

In each of the above-described preferred embodiments, the filling roller 50 is preferably a rotatable roller. Alternatively, the filling roller 50 may be a roller that cannot rotate relative to the body 10. In each preferred embodiment, the filler according to preferred embodiments of the present invention is preferably the filling roller 50. Alternatively, the filler is not limited to the filling roller 50. For example, the filler according to preferred embodiments of the present invention may be a plate-shaped member extending vertically and located above the modeling movement space 16. This plate-shaped member may preferably be made of a flexible material, such as rubber, for example. With such a plate-shaped member, the modeling space 21 of the modeling tank 20 is also able to be filled with the powder material 5.

In each preferred embodiment, with the positions of the supply port 46 of the powder supplier 40, the filling roller 50, the modeling head 60, the plurality of ink heads 62, and the heater 70 being fixed relative to the body 10, the conveyor 80 moves the modeling tank 20 laterally so that the modeling tank 20 is caused to move relative to the supply port 46 of the powder supplier 40, the filling roller 50, the modeling head 60, the plurality of ink heads 62, and the heater 70. Alternatively, the conveyor 80 may integrally move the supply port 46 of the powder supplier 40, the filling roller 50, the modeling head 60, the plurality of ink heads 62, and the heater 70 laterally so that the modeling tank 20 is able to move relative to the supply port 46 of the powder supplier 40, the filling roller 50, the modeling head 60, the plurality of ink heads 62, and the heater 70. In this case, the position of the modeling tank 20 is preferably fixed.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional modeling apparatus comprising:
a modeling tank including a modeling space that houses a powder material;
a modeling table disposed in the modeling space of the modeling tank, the powder material being placed on the modeling table;
a first powder supplier including a first supply port and that supplies the powder material into the modeling space of the modeling tank;
a first filler that fills the modeling space with the powder material supplied from the first powder supplier;
a first modeling head that discharges a curing liquid to the powder material placed on the modeling table; and
a conveyor that moves the modeling tank at least from an upstream side to a downstream side relative to the first powder supplier, the first filler, and the first modeling head, where the upstream side is one side in a predetermined first direction and the downstream side is another side in the first direction; wherein
the first supply port of the first powder supplier is disposed upstream of the first filler and the first modeling head; and
the first filler is disposed at the upstream side of the first modeling head.

2. The three-dimensional modeling apparatus according to claim 1, wherein in plan view, the modeling tank, the modeling table, the first supply port of the first powder supplier, the first filler, and the first modeling head are disposed along a line extending in the first direction.

3. The three-dimensional modeling apparatus according to claim 1, further comprising:
a body slidably housing the modeling tank and including a modeling movement space extending in the first direction; wherein
the first supply port of the first powder supplier, the first filler, and the first modeling head are disposed above the modeling movement space.

4. The three-dimensional modeling apparatus according to claim 3, wherein
the first powder supplier, the first filler, and the first modeling head are disposed so that positions of the first powder supplier, the first filler, and the first modeling head are fixed relative to the body; and
the conveyor moves the modeling tank at least from the upstream side to the downstream side in the modeling movement space.

5. The three-dimensional modeling apparatus according to claim 1, further comprising a surplus powder container disposed upstream of the modeling tank and that houses the powder material removed from the modeling tank by the first filler.

6. The three-dimensional modeling apparatus according to claim 1, further comprising a heater disposed downstream of the first modeling head and that applies heat to the powder material in the modeling tank.

7. The three-dimensional modeling apparatus according to claim 1, wherein
the first powder supplier includes:
a supply vessel including the first supply port; and
a feeder that supplies the powder material to the modeling tank through the first supply port; wherein
a length of the first supply port in a predetermined second direction intersecting the first direction in plan view is less than or equal to a length of the modeling space in the second direction.

8. The three-dimensional modeling apparatus according to claim 1, wherein
the first modeling head includes a bottom surface in which a plurality of nozzles disposed in a second direction intersecting the first direction in plan view are provided; and
a nozzle array defined by the plurality of nozzles has a length in the second direction that is less than or equal to a length of the modeling space in the second direction.

9. The three-dimensional modeling apparatus according to claim 1, wherein the first filler includes a filling roller rotatable about a rotation shaft that extends in a predetermined second direction intersecting the first direction in plan view.

10. The three-dimensional modeling apparatus according to claim 9, wherein a length of the filling roller in the second direction is greater than or equal to a length of the modeling space in the second direction.

11. The three-dimensional modeling apparatus according to claim 9, further comprising a powder reconveyor contacting the filling roller and that removes the powder material attached to at least the filling roller.

12. The three-dimensional modeling apparatus according to claim 1, further comprising:
a controller configured or programmed to control the first powder supplier, the first modeling head, and the conveyor; wherein
the controller is configured or programmed to include a movement controller that controls the conveyor such that the modeling tank relatively moves from a start position to a stop position, where the start position is a predetermined position upstream of the first supply port of the first powder supplier and the stop position is a predetermined position downstream of the first modeling head.

13. The three-dimensional modeling apparatus according to claim 12, wherein the movement controller controls the conveyor to prevent the modeling tank from stopping while the modeling tank moves from the start position to the stop position.

14. The three-dimensional modeling apparatus according to claim 12, wherein the controller is configured or programmed to include:
a supply controller that supplies the powder material from the first powder supplier to the modeling tank when the modeling tank is moved by the conveyor to be located below the first supply port of the first powder supplier; and
a discharge controller that discharges the curing liquid from the first modeling head when the modeling tank is moved by the conveyor to be located below the first modeling head.

15. The three-dimensional modeling apparatus according to claim 1, further comprising:
a second powder supplier disposed downstream of the first modeling head, that supplies the powder material to the modeling space of the modeling tank, and including a second supply port; and
a second filler disposed between the first modeling head and the second supply port of the second powder supplier in plan view and that fills the modeling space with the powder material supplied from the second powder supplier; wherein
the conveyor moves the modeling tank in a direction from the upstream side to the downstream side and in a direction from the downstream side to the upstream side relative to the first powder supplier, the first filler, the first modeling head, the second powder supplier, and the second filler.

16. The three-dimensional modeling apparatus according to claim 1, further comprising:
a second filler disposed upstream of the first supply port of the first powder supplier and that fills the modeling space with the powder material supplied from the first powder supplier; and
a second modeling head disposed upstream of the second filler and that discharges the curing liquid to the powder material placed on the modeling table; wherein
the conveyor moves the modeling tank in a direction from the upstream side to the downstream side and in a direction from the downstream side to the upstream side relative to the first powder supplier, the first filler, the first modeling head, the second filler, and the second modeling head.
